(19) United States
(12) Patent Application Publication
(10) Pub. No.: US 2006/0116193 A1
(43) Pub. Date: Jun. 1, 2006

(54) Gaming machine

(75) Inventor: Kazunobu Sato, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORPORATION

(21) Appl. No.: 11/285,116

(22) Filed: Nov. 23, 2005

(30) Foreign Application Priority Data
Nov. 29, 2004 (JP) 2004-344057

(51) Int. Cl. A63F 13/00

(52) U.S. Cl. 463/20; 463/25

(57) ABSTRACT

In the slot machine 1, after scroll and stop of the symbols of the variable display portions 21 to 25 are conducted, if the player touches any of the variable display portions 21 to 25, scroll and stop of the symbols are again conducted in the variable display portions 21 to 25 touched by the player. For example, after scroll and stop of the symbols are done in all of the variable display portions 21 to 25, if the player touches the variable display portions 24, 25, the symbols are again scrolled and stopped in the variable display portions 24, 25 touched by the player.

### CROSS-REFERENCE TO THE RELATED APPLICATION(S)

This application is based upon and claims a priority from the prior Japanese Patent Application No. 2004-344057 filed on Nov. 29, 2004, the entire contents thereof are incorporated herein by reference.

### BACKGROUND OF THE INVENTION

1. Field of the Invention

The present invention relates to a gaming machine in which a game is conducted by using a symbol combination on a plurality of reels variably displayed and stopped.

2. Description of Related Art

In a conventional gaming machine, for example, a slot machine, it is constructed so that a plurality of reels are rotated for a predetermined time and coins are paid out corresponding to a symbol combination in a state that the reels are stopped. Further, in the slot machine disclosed in Unexamined Japanese Publication No. 2002-320713, in a case that a bonus symbol, which becomes a chance to shift a game state to a bonus game, is displayed when each of the reels is stopped, a wild symbol substitutable for any of the symbols is displayed instead of the bonus symbol, and the game state shifts to the bonus game while retaining a state that the wild symbol is displayed, thereby it is attempted to raise expectation of a player and amusement characteristic.

Here, since the wild symbol is the symbol which can be regarded as any of the symbols and the bonus game conducted thereafter is also the game in which coins are paid out corresponding to the symbol combination, it is certainly beneficial for the player to retain a state that the wild symbol is displayed. However, the state that the wild symbol is displayed is automatically retained with no relation of player's intention, therefore strategy of the player cannot be reflected on the game.

### SUMMARY OF THE INVENTION

Therefore, in order to accomplish the above problems, the present invention has been done and has an object to provide a gaming machine in which strategy of the player can be reflected on a game which is conducted by using a symbol combination variably displayed and stopped on the reels.

In order to accomplish the above object, according to one aspect of the present invention, it is provided a gaming machine comprising:

a reel display device for displaying a plurality of reels each of which has symbols and is rotated so as to variably display and stop the symbols;

a payout device for paying out game media if a symbol combination constructed from the symbols of the reels corresponds to a winning symbol combination when the reels are stopped;

a selection device for selecting the reel which is rotated;

an acceptance device for accepting a selective instruction from the selection device;

wherein the acceptance device accepts the selective instruction only when the selective instruction is output from the selection device after all of the reels are stopped,

wherein the reel display device displays the reel so as to again rotate corresponding to the selective instruction accepted by the acceptance device, and

wherein the payout device pays out the gaming media if the symbol combination constructed from the symbols including the symbol of the reel which is again rotated and stopped corresponds to the winning symbol combination.

According to the gaming machine of the present invention, in order to obtain more game media, the player can select the reel which is rotated through the selection device after all of the reels are stopped and the payout device pays out the gaming media if the symbol combination constructed from the symbols including the symbol of the reel which is again rotated and stopped corresponds to the winning symbol combination. Thereby, the strategy of the player can be reflected on the game which is conducted by using the symbol combination on the reels.

Further, according to another aspect of the present invention, it is provided a gaming machine comprising:

a reel display device for displaying a plurality of reels each of which has symbols and is rotated so as to variably display and stop the symbols;

a payout device for paying out game media if a symbol combination constructed from the symbols of the reels corresponds to a winning symbol combination when the reels are stopped;

a selection device for selecting the reels which are fixed so as not to rotate;

an acceptance device for accepting a selective instruction from the selection device;

wherein the acceptance device accepts the selective instruction only when the selective instruction is output from the selection device after all of the reels are stopped,

wherein the reel display device displays the reels not selected by the selection device so as to again rotate; and

wherein the payout device pays out the gaming media if the symbol combination constructed from the symbols including the symbols of the reels which are again rotated and stopped corresponds to the winning symbol combination.

According to the gaming machine of the present invention, in order to obtain more game media, the player can select the reel which is fixed so as not to rotate through the selection device after all of the reels are stopped and the payout device pays out the gaming media if the symbol combination constructed from the symbols including the symbols of the reels which are again rotated and stopped corresponds to the winning symbol combination. Thereby, the strategy of the player can be reflected on the game which is conducted by using the symbol combination on the reels.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is an explanatory view showing one example of five variable display portions when scroll and stop of symbols are again conducted,

FIG. 2 is an explanatory view showing one example of five variable display portions when scroll and stop of symbols are again conducted,

FIG. 3 is an explanatory view showing one example of five variable display portions when scroll and stop of symbols are conducted,

FIG. 4 is an explanatory view showing one example of a winning symbol combination realized in FIG. 3,

FIG. 5 is an explanatory view showing one example of a winning symbol combination realized in FIG. 3,

FIG. 6 is a flowchart of a first re-rotation process program,

FIG. 7 is a flowchart of a second re-rotation process program,

FIG. 8 is a perspective view of a slot machine according to the embodiment,

FIG. 9 is a front view of a control panel in the embodiment,

FIG. 10 is a block diagram schematically showing a control system of the slot machine of the embodiment,

FIG. 11 is a block diagram showing a liquid crystal drive circuit of liquid crystal displays in the embodiment,

FIG. 12 is an explanatory view schematically showing an example of symbol columns variably displayed on variable display portions in a base game conducted in the slot machine of the embodiment,

FIG. 13 is an explanatory view showing winning symbol combinations and payouts thereof in the embodiment,

FIG. 14 is an explanatory view showing stop display areas of five variable display portions,

FIG. 15 is a flowchart of a main process program,

FIG. 16 is a flowchart of a start acceptance process program,

FIG. 17 is a flowchart of a lottery process program,

FIG. 18 is a flowchart of a base game process program,

FIG. 19 is a flowchart of a bonus game process program, and

FIG. 20 is an explanatory view showing a lottery table of stop display symbols.

### DETAILED DESCRIPTION OF THE PREFERRED EMBODIMENTS

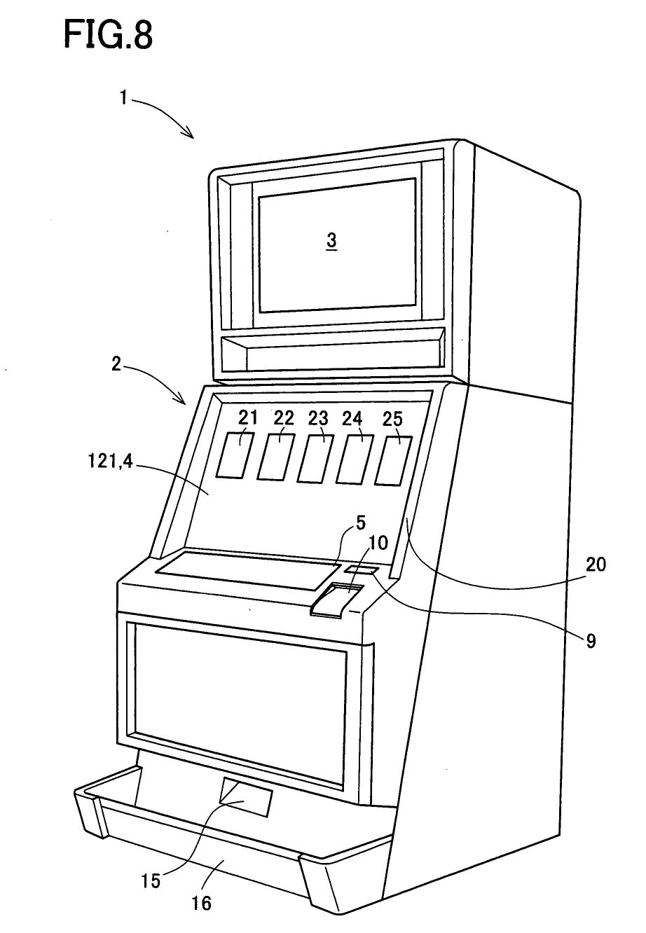

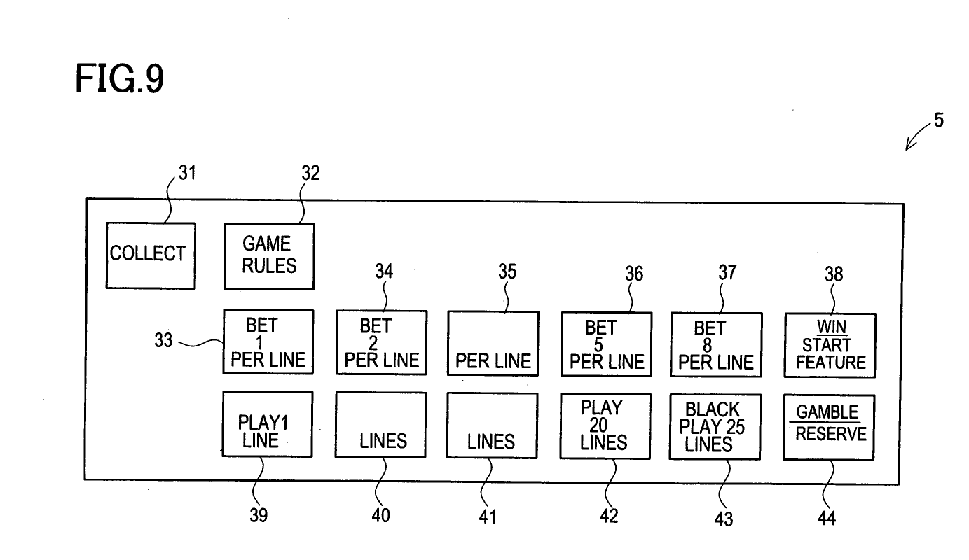

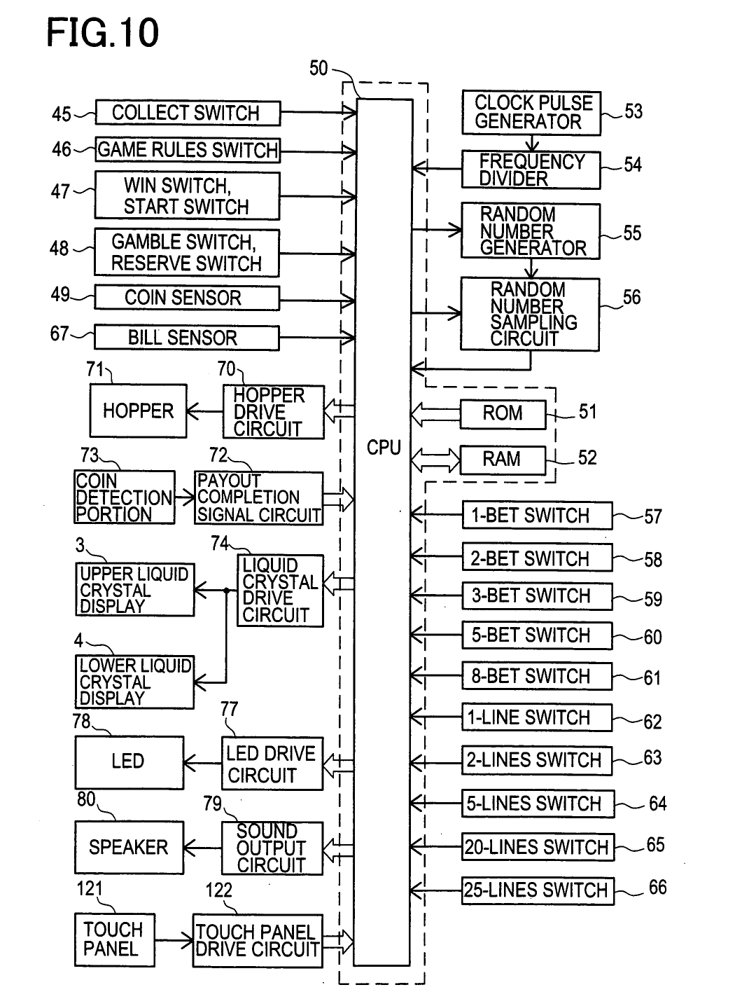

Hereinafter, concerning with a gaming machine according to the present invention, embodiments embodying the present invention in a slot machine will be described in detail with reference to the drawings. First, an outline construction of the slot machine according to the embodiment will be described with reference to FIGS. 8 to 10. FIG. 8 is a perspective view of the slot machine. FIG. 9 is a front view of a control panel. FIG. 10 is a block diagram schematically showing a control system of the slot machine.

In FIG. 8, the slot machine 1 has a cabinet 2 which forms whole construction of the slot machine 1. At an upper position of a front plane of the cabinet 2, an upper liquid crystal display 3 is arranged and a lower liquid crystal display 4 is arranged on a device front panel 20 which is arranged at a center position of the front plane of the cabinet 2. Here, both the upper liquid crystal display 3 and the lower liquid crystal display 4 are constructed from liquid crystal display generally used. On the upper liquid crystal display 3, it is indicated information concerning with a game such as methods, kinds of winning symbol combinations and payouts corresponding thereto and various effects. And on a surface of the lower liquid crystal display 4, credits are displayed and five variable display portions 21, 22, 23, 24 and 25 are basically displayed as shown in FIG. 8. On each of the variable display portion 21, 22, 23, 24 and 25, various symbols are variably displayed while being scrolled (hereinafter, called as “scroll display”) from an upper direction toward a lower direction, thereafter stopped and displayed.

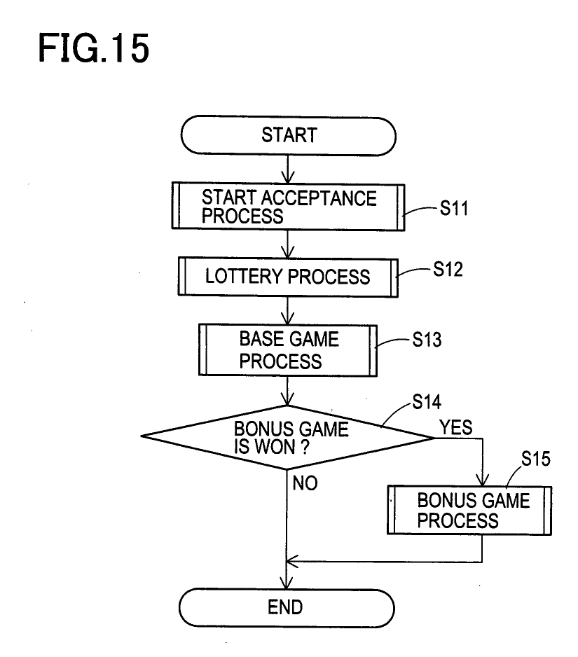

Therefore, in the slot machine 1 of the embodiment, a slot game (there exist a base game and a bonus game) is conducted through a video reels which are realized by displaying variable display portions 21 to 25 on the lower liquid crystal display 4. In the slot game (there exist a base game and a bonus game), there exist three symbols stopped and displayed on each of the variable display portions 21 to 25. That is to say, as shown in FIG. 15, the variable display portions 21 to 25 are divided into first stop areas 211, 221, 231, 241, 251, second stop areas 212, 222, 232, 242, 252, and third stop areas 213, 223, 233, 243, 253. And the symbols are respectively stopped and displayed on the stop areas 211˜213, 221˜223, 231˜233, 241˜243, 251˜253.

And in this slot game (base game and bonus game), there exist twenty-five pay lines, each spanning five stop areas among the stop areas 211˜213, 221˜223, 231˜233, 241˜243, 251˜253. If each of the pay lines is activated and specific symbols are aligned with a specific display mode along the activated pay line when the symbols are stopped and displayed, a predetermined payout is given to the player. Here, explanation of 25 pay lines will be omitted.

And here, the word “game” means a series of operations that in the base game bet operation is done based on credits retained at present, the symbols are variably displayed and stopped, and various processes (bonus game and payout process) corresponding to the symbol combination stopped and displayed are conducted. Therefore, the word “game” used in the base game is distinguished from the word “game” used in the bonus game.

Here, the pay line (s) activated among the 25 pay lines is/are called as “activated pay line (s)”

Back to FIG. 8, at an lower position of the lower liquid crystal display 4, a control panel 5 which is projected forward is formed. In the control panel 5 as shown in FIG. 9, a COLLECT button 31 and a GAME RULES button 32 are arranged in an upper step from the most left side, and a BET 1 PER LINE button 33, a BET 2 PER LINE button 34, a BET 3 PER LINE button 35, a BET 5 PER LINE button 36, a BET 8 PER LINE button 37 and a WIN START FEATURE button 38 are arranged in a middle step from the most left side. Further, a RED PLAY 1 LINE button 39, a PLAY 2 LINES button 40, a PLAY 5 LINES button 41, a PLAY 20 LINES button 42, a BLACK PLAY 25 LINES button 43 and a GAMBLE RESERVE button 44 are arranged in a lower step from the most left side. And as shown in FIG. 8, at the right side of the control panel 5, a coin insertion slot 9 and a bill insertion portion 10 are provided.

Here, the COLLECT button 31 is a button which is pressed when the base game is terminated, and when the COLLECT button 31 is pressed, coins equal to the credits obtained in the game are paid out from a coin payout opening 15 to a coin tray 16. To the COLLECT button 31, a COLLECT switch 45 is attached and a switch signal is output to a CPU 50 from the COLLECT switch 45 on the basis of press of the COLLECT button 31 (see FIG. 10).

The GAME RULES button 32 is a button which is pressed if operation methods of the game cannot be understood, and when the GAME RULES button 32 is pressed, various help information is displayed on the upper liquid crystal display 3 or the lower liquid crystal display 4. To the GAME RULES button 32, a GAME RULES switch 46 is attached and a switch signal is output to the CPU 50 from the GAME RULES switch 46 on the basis of press of the GAME RULES button 32 (see FIG. 10).

To the coin insertion slot 9, a coin sensor 49 is arranged and when a coin is inserted in the coin insertion slot 9, a coin detection signal is output to the CPU 50 through the coin sensor 49 (see FIG. 10) and credit corresponding to the inserted coin is added. And to the bill insertion portion 10, a bill sensor 67 is arranged and when a bill is inserted in the bill insertion portion 10, a bill detection signal is output to the CPU 50 through the bill sensor 67 (see FIG. 10), and credit corresponding to the inserted bill is added.

The BET 1 PER LINE button 33 is a button to bet one credit to each of the activated pay lines every one press thereof. To this BET 1 PER LINE button 33, a 1-BET switch 57 is attached and when the BET 1 PER LINE button 33 is pressed, a switch signal is output to the CPU 50 from the 1-BET switch 57 (see FIG. 10). The BET 2 PER LINE button 34 is a button to start the game with 2 bets against each of the activated pay lines on the basis of press thereof. To the BET 2 PER LINE button 34, a 2-BET switch 58 is attached and when the BET 2 PER LINE button 34 is pressed, a switch signal is output to the CPU 50 from the 2-BET switch 58 (see FIG. 10).

The BET 3 PER LINE button 35 is a button to start the game wit 3 bets against each of the activated pay lines on the basis of press thereof. To the BET 3 PER LINE button 35, a 3-BET switch 59 is attached and when the BET 3 PER LINE button 35 is pressed, a switch signal is output to the CPU 50 from the 3-BET switch 59 (see FIG. 10). And the BET 5 PER LINE button 36 is a button to start the game with 5 bets against each of the activated pay lines on the basis of press thereof. To the BET 5 PER LINE button 36, a 5-BET switch 60 is attached and when the BET 5 PER LINE button 36 is pressed, a switch signal is output to the CPU from the 5-BET switch 60 (see FIG. 10).

The BET 8 PER LINE button 37 is a button to start the game with 8 bets against each of the activated pay lines on the basis of press thereof. To the BET 8 PER LINE button 37, a 8-BET switch 61 is attached and when the BET 8 PER LINE switch 37 is pressed, a switch signal is output to the CPU 50 from the 8-BET switch 61 (see FIG. 10). Therefore, the bet number betted per one line among the pay lines activated is determined by press of the BET 1 PER LINE button 33, the BET 2 PER LINE button 34, the BET 3 PER LINE button 35, the BET 5 PER LINE button 36 and the BET 8 PER LINE button 37.

The WIN START FEATURE button 38 is a button to start a bonus game or add the payout obtained in the bonus game to the credit on the basis of press thereof. To the WIN START FEATURE button 38, a WIN START switch 47 is attached and when the WIN START FEATURE button 38 is pressed, a switch signal is output to the CPU 50 from the WIN START switch 47 (see FIG. 10).

The RED PLAY 1 LINE button 39 is a button to start the game while retaining the number of the activated pay line to “1” on the basis of press thereof. To the RED PLAY 1 LINE button 39, a 1-LINE switch 62 is attached and when the RED PLAY 1 LINE button 39 is pressed, a switch signal is output to the CPU 50 from the 1-LINE switch 62 (see FIG. 10). And the PLAY 2 LINES button 40 is a button to start the game while retaining the number of the activated pay line to “2” on the basis of press thereof. To the PLAY 2 LINES button 49, a 2-LINES switch 63 is attached and when the PLAY 2 LINES button 40 is pressed, a switch signal is output to the CPU 50 from the 2-LINES switch 63 (see FIG. 10).

The PLAY 5 LINES button 41 is a button to start the game while retaining the number of the activated pay line to “5” on the basis of press thereof. To the PLAY 5 LINES button 41, a 5-LINES switch 64 is attached and when the PLAY 5 LINES button 41 is pressed, a switch signal is output to the CPU 50 from the 5-LINES switch 64 (see FIG. 10). And the PLAY 20 LINES button 42 is a button to start the game while retaining the number of the activated pay line to “20” on the basis of press thereof. To the PLAY 20 LINES button 42, a 20-LINES switch 65 is attached and when the PLAY 20 LINES button 42 is pressed, a switch signal is output to the CPU 50 from the 20-LINES switch 65 (see FIG. 10).

The BLACK PLAY 25 LINES button 43 is a button to start the game while retaining the number of the activated pay line to “25” on the basis of press thereof. To the BLACK PLAY 25 LINES button 43, a 25-LINES switch 66 is attached and when the BLACK PLAY 25 LINES button 43 is pressed, a switch signal is output to the CPU 50 from the 25-LINES switch 66 (see FIG. 10).

Therefore, there will exist “1” pay line, “2” pay lines, “5” pay lines, “20” pay lines and “25” pay lines as the number of the activated pay lines which can be determined by press of the RED PLAY 1 LINE button 39, the PLAY 2 LINES button 49, the PLAY 5 LINES button 41, the PLAY 20 LINES button 42, the BLACK PLAY 25 LINES button 43.

And each of the RED PLAY 1 LINE button 39, the PLAY 2 LINES button 49, the PLAY 5 LINES button 41, the PLAY 20 LINES button 42 and the BLACK PLAY 25 LINES button 43 is a button to start the game with the present bet number and the number of the activated pay lines and to start variable display of the symbols on each of the variable display portions 21 to 25 in the lower liquid crystal display 4.

Here, the RED PLAY 1 LINE button 39 and the BLACK PLAY 25 LINES button 43 are also used for selecting red or black in the double down game which is conducted by using the credit obtained in the bonus game.

The GAMBLE RESERVE button 44 is a button to be pressed when the player leaves the seat and to shift to the double down game after the bonus game is terminated. To the GAMBLE RESERVE button 44, a GAMBLE˜RESERVE switch 48 is attached and when the GAMBLE RESERVE button 44 is pressed, a switch signal is output to the CPU 50 from the GAMBLE˜RESERVE switch 48 (see FIG. 10).

And at a lower position of the cabinet 2, a coin payout opening 15 is formed and a coin tray 16 for receiving coins paid out from the coin payout opening 15 is provided. Within the coin payout opening 15 it is arranged a coin detection portion 73 (mentioned later) which is constructed from sensors and the like (see FIG. 10). And the coin detection portion 73 counts the number of coins paid out from the coin payout opening 15.

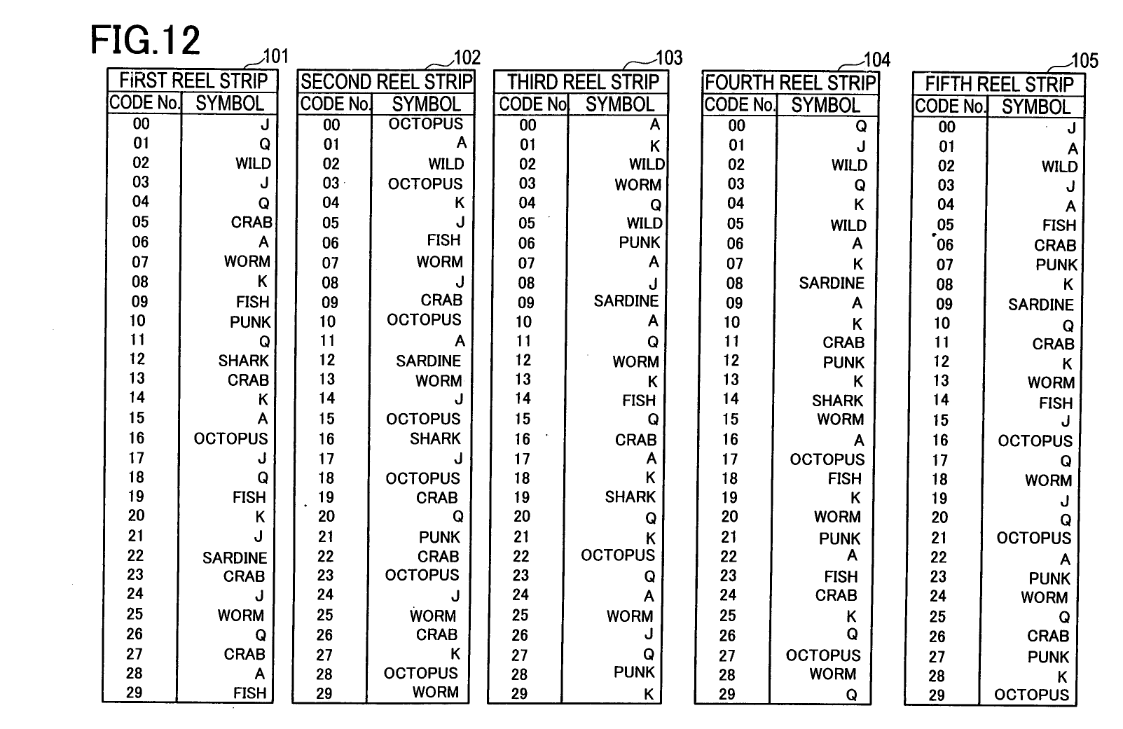

Next, with reference to FIG. 12, it will be described the symbol columns which are variably displayed while being scrolled on each of the variable display portions 21 to 25, the symbol columns being displayed on the lower liquid crystal display 4 in the base game. In FIG. 12, the symbol column indicated by a first reel strip 101 corresponds to a symbol column variably displayed on the variable display portion 21, the symbol column indicated by a second reel strip 102 corresponds to a symbol column variably displayed on the display portion 22, the symbol column indicated by a third reel strip 103 corresponds to a symbol column variably displayed on the variable display portion 23, the symbol column indicated by a fourth reel strip 104 corresponds to a symbol column variably displayed on the variable display portion 24 and the symbol column indicated by a fifth reel strip 105 corresponds to a symbol column variably displayed on the variable display portion 25.

Here, the symbol columns respectively indicated by the first to fifth reel strips 101 to 105 have different symbol columns from each other and each symbol column is constructed from 12 symbols by voluntarily combining “WILD”, “SHARK”, “FISH”, “PUNK”, “OCTOPUS”, “CRAB”, “WORM”, “A”, “K”, “Q”, “J” and “SARDINE”.

Here, although “SHARK”, “FISH”, “PUNK”, “OCTOPUS”, “CRAB”, “WORM”, “SARDINE” are not shown, each symbol shows a shark, a fish, a person having a guitar, an octopus, a crab, a worm and a sardine, respectively. And each of “WILD”, “A”, “K”, “Q” and “J” shows a symbol of English character (S), respectively.

Further, “SARDINE” is a scatter symbol to shift to the bonus game as mentioned later and in a case that more than three “SARDINE” symbols are totally displayed on the variable display portions 21 to 25, the game state can be shifted to the bonus game.

And “WILD” is an almighty symbol which can be substituted for any of “SHARK”, “FISH”, “PUNK”, “OCTOPUS”, “CRAB”, “WORM”, “A”, “K”, “Q” and “J”. However, “WILD” cannot be substituted for “SARDINE” which is the scatter symbol.

Here, in a case that the symbol columns indicated by the first to fifth reel strips 101 to 105 are scrolled on the variable display portions 21 to 25 and thereafter stopped and displayed, three symbols are stopped and displayed in each variable display portion, as mentioned in the above.

And various winning symbol combinations are preset based on plural kinds of symbol combinations and when the symbol combination corresponding to the winning symbol combination is stopped on the activated pay line, the payout is added to the credit corresponding to the winning symbol combination. This point is as same as that in the convention slot machine, thus explanation thereof will be omitted.

Next, it will be described a construction of control system in the slot machine 1 with reference to FIG. 10. FIG. 10 is a block diagram schematically showing a control system of the slot machine 1.

In FIG. 10, the control system of the slot machine 1 is basically constructed from a CPU 50, and a ROM 51 and a RAM 52 are connected to the CPU 50. In the ROM 51, a main process program mentioned later, a base game process program, a bonus game process program, a first lottery table used when it is conducted a lottery to determine the symbols which are stopped and displayed in the base game, a second lottery table used when it is conducted a lottery to determine the symbols which are stopped and displayed in the bonus game, and the other various programs necessary for control of the slot machine 1 and data tables. And the RAM 52 is a memory to temporarily store various data calculated by the CPU 50.

And to the CPU 50, a clock pulse generator 53 for generating standard clock pulses and a frequency divider 54 are connected, and a random number generator 55 for generating random numbers and a random number sampling circuit 56 are also connected. The random number sampled through the random number sampling circuit 56 is utilized in various lotteries of the winning symbol combinations and the like. Further, to the CPU 50, the COLLECT switch 45 attached to the COLLECT button 31, the GAME-RULES switch 46 attached to the GAME RULES button 32, the 1-BET switch 57 attached to the BET 1 PER LINE button 33, the 2-BET switch 58 attached to the BET 2 PER LINES button 34, the 3-BET switch 59 attached to the BET 3 PER LINES button 35, the 5-BET switch 60 attached to the BET 5 PER LINES button 36, the 8-BET switch 60 attached to the BET 8 PER LINES button 37, the WIN-START switch 47 attached to the WIN START FEATURE button 38, the 1-LINE switch 62 attached to the RED PLAY 1 LINE button 39, the 2-LINES switch 63 attached to the PLAY 2 LINES button 40, the 5-LINES switch 64 attached to the PLAY 5 LINES button 41, the 20-LINES switch 65 attached to the PLAY 20 LINES button 42, the 25-LINES switch 66 attached to the BLACK PLAY 25 LINES button 43 and the GAMBLE .RESERVE switch 48 attached to the GAMBLE RESERVE button 44 are connected, respectively. The CPU 50 conducts control to execute various operations each of which corresponds to each button, based on the switch signal output from each switch by press thereof.

Further, to the CPU 50, the coin sensor 49 arranged in the coin insertion slot 9 and the bill sensor 67 arranged in the bill insertion portion 10 are respectively connected. The coin sensor 49 detects coins inserted from the coin insertion slot 9 and the CPU 50 calculates the number of inserted coins based on the coin detection signal output from the coin sensor 49. The bill sensor 67 detects kinds and sum of the bill inserted from the bill insertion portion 10 and the CPU 50 calculates the credit number equal to the sum of bill, based on the bill detection signal output from the bill sensor 67.

To the CPU 50, a hopper 71 is connected through a hopper drive circuit 70. When a drive signal is output to the hopper drive circuit 70 from the CPU 50, the hopper 71 pays out a predetermined number of coins from the coin payout opening 15.

And to the CPU 50, a coin detection portion 73 is connected through a payout completion signal circuit 72. The coin detection portion 73 is arranged in the coin payout opening 15 and when the coin detection portion 73 detects that a predetermined number of coins are paid out from the coin payout opening 15, a coin payout detection signal is output to the payout completion signal circuit 72 from the coin detection portion 73, thereby the payout completion signal circuit 72 outputs a payout completion signal to the CPU 50. Further, to the CPU 50, the upper liquid crystal display 3 and the lower liquid crystal display 4 are connected through a liquid crystal drive circuit 74, and the upper liquid crystal display 3 and the lower liquid crystal display 4 are controlled by the CPU 50.

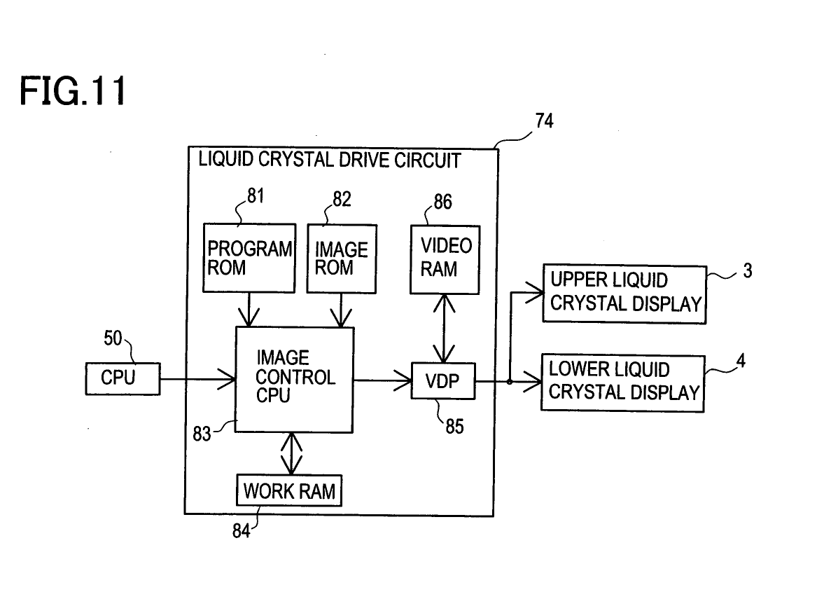

Here, as shown in FIG. 11, the liquid crystal drive circuit 74 is constructed from a program ROM 81, an image ROM 82, an image control CPU 83, a work RAM 84, a VDP (video display processor) 85 and a video RAM 68. And in the program ROM 81, there are stored an image control program for controlling display of the upper liquid crystal display 3 and the lower liquid crystal display 4 and various selection tables. And in the image ROM 82, for example, there are stored dot data for forming images of the symbol columns indicated by the first to fifth reel strips 101 to 105 in FIG. 12, such images being displayed on the lower liquid crystal display 4 (or variable display portions 21 to 25). And the image control CPU 83 determines the images displayed on the upper liquid crystal display 3 and the lower liquid crystal display 4 among the dot data stored beforehand in the image ROM 82, according to the image control program stored beforehand in the program ROM 81 based on parameters set by the CPU 50. Further, the work RAM 84 functions as temporary memory when the image control program is executed by the image control CPU 83. And the VDP 85 forms images corresponding to display contents determined by the image control CPU 83 and outputs such images to the upper liquid crystal display 3 and the lower liquid crystal display 4. Thereby, for example, the symbol columns indicated by the first to fifth reel strips 101 to 105 are scrolled and displayed on the lower liquid crystal display 4 (or the variable display portions 21 to 25). Here, the video RAM 86 functions as temporary memory when images are formed by the VDP 85.

And to the CPU 50, LEDs 78 are connected through a LED drive circuit 77. Many LEDs 78 are arranged on the front plane of the slot machine 1 and are controlled so as to turn on or turn off by the LED drive circuit 77 based on the drive signal from the CPU 50, when various effects are done. Further, a sound output circuit 79 and a speaker 80 are connected to the CPU 50 and the speaker 80 produces various effect sounds when various effects are conducted based on the output signal from the sound output circuit 79.

And to the CPU 50, a touch panel 121 is connected through a touch panel drive circuit 122. The touch panel 121 is provided on the image plane of the lower liquid crystal display 4, and when the player touches within any of the variable display portions 21 to 25, it is recognized through the touch panel 121 not only the variable display portion which is touched among the variable display portions 21 to 25 but also the stop display area which is touched among the first stop display areas 211, 221, 231, 241, 251, the second stop display portions 212, 222, 232, 242, 252 and the third stop display portions 213, 223, 233, 243, 253.

That is to say, the touch panel 121 can recognize the variable display portion which is touched among the variable display portions 21 to 25, based on coordinate information of the portion which is touched by the player, through the touch panel drive circuit 122.

Here, it will be described the first lottery table which is used when the symbols stopped and displayed on the activated pay line constructed from the second stop display areas 212, 222, 232, 242, 252 of the variable display portions 21 to 25 are determined, when the base game is conducted by using five variable display portions 21 to 25 in the slot machine 1.

The symbols stopped and displayed on the activated pay line constructed from the second stop display areas 212, 222, 232, 242 and 252 in the variable display portions 21 to 25 are determined every each of the variable display portions 21 to 25. In order to realize this, code Nos. “00”˜“29” are respectively allotted to the symbols in each symbol column indicated by the first to fifth reel strips 101 to 105 as shown in FIG. 12, in order of the upper most symbol. And in the first lottery table, one random number is corresponded to each of the code Nos.. Further, five random numbers are sampled by the random number sampling circuit 56 so as to correspond to each of the variable display portions 21 to 25, thereby the symbols stopped and displayed on the pay line activated are determined.

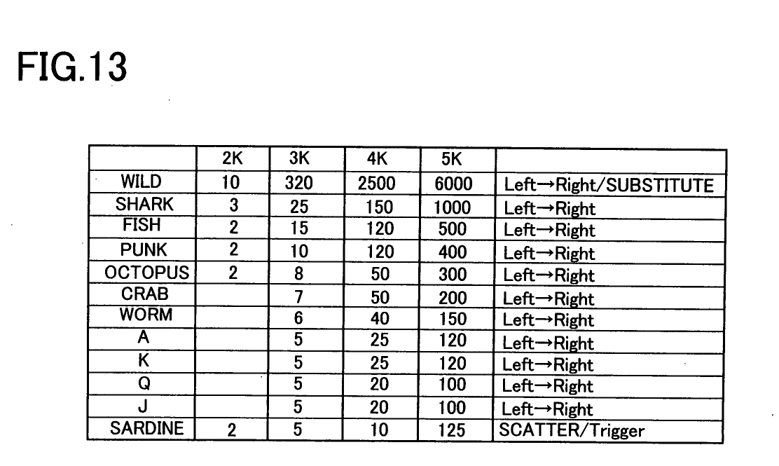

Next, with reference to FIG. 13, it will be described the winning symbol combinations and payouts thereof in a case that the base game is executed by using five variable display portions 21 to 25 in the slot machine 1. FIG. 13 is an explanatory view showing the winning symbol combinations and payouts thereof in a case that the base game is executed by using five variable display portions 21 to 25, and shows payouts in a case that the bet number is “1”. Therefore, if the bet number is “1”, the payout number shown in FIG. 13 is added to the credit, and if the bet number is more than “2”, the value obtained by multiplying the bet number with the payout number shown in FIG. 13 is added to the credit.

Here, concretely describing the winning symbol combinations and payouts thereof in the base game, as shown in FIG. 13, if the symbols “WILD” (shown in FIG. 13) are stopped and displayed in series along the activated pay line on the variable display portions 21 and 22 (if two symbols “WILD” appear in series from the left end (this case is called as “2K”)), the payout number “10” can be obtained. And if the symbols “WILD” are stopped and displayed in series along the activated pay line on the variable display portions 21 to 23 (if three symbols “WILD” appear in series from the left end (this case is called as “3K”)), the payout number “320” can be obtained. Further, if the symbols “WILD” are stopped and displayed in series along the activated pay line on the variable display portions 21 to 24 (if four symbols “WILD” appear in series from the left end (this case is called as “4K”)), the payout number “2500” can be obtained. And if the symbols “WILD” are stopped and displayed in series along the activated pay line on the variable display portions 21 to 25 (if five symbols “WILD” appear in series from the left end (this case is called as “5K”)), the payout number “6000” can be obtained.

And as for the symbol “SHARK”, if the symbols “SHARK” are stopped and displayed in series along the activated pay line on the variable display portions 21 and 22 (if two symbols “SHARK” appear in series from the left end (this case is called as “2K”)), the payout number “3” can be obtained. And if the symbols “SHARK” are stopped and displayed in series along the activated pay line on the variable display portions 21 to 23 (if three symbols “SHARK” appear in series from the left end (this case is called as “3K”)), the payout number “25” can be obtained. Further, if the symbols “SHARK” are stopped and displayed in series along the activated pay line on the variable display portions 21 to 24 (if four symbols “SHARK” appear in series from the left end (this case is called as “4K”)), the payout number “150” can be obtained. And if the symbols “SHARK” are stopped and displayed in series along the activated pay line on the variable display portions 21 to 25 (if five symbols “SHARK” appear in series from the left end (this case is called as “5K”)), the payout number “1000” can be obtained.

Here, as mentioned in the above, the symbol “WILD” can be substituted for the symbol “SHARK”.

Hereinafter, similar to the above case, as for the symbol “FISH”, the symbol “PUNK” (showing a person having a guitar), the symbol “OCTOPUS”, the symbol “CRAB”, the symbol “WORM”, the symbol “A” (English character), the symbol “K” (English character), the symbol “Q” (English character), the symbol “J” (English character), the payout for each of the above symbols is set as shown in FIG. 13 and the symbol “WILD” is substitutable for each of the symbol.

And in a case that the above payout is realized on plural activated pay lines, all payouts are added to the credit.

On the other hand, as for the symbol “SARDINE”, if two symbols “SARDINE” appear (are stopped and displayed) on the variable display portions 21 to 25 with no relation to the activated pay lines, that is, if the case “2K” is realized, the payout number “2” can be obtained. If three symbols “SARDINE” appear (are stopped and displayed) on the variable display portions 21 to 25 with no relation to the activated pay lines, that is, if the case “3K” is realized, the payout number “5” can be obtained. And if four symbols “SARDINE” appear (are stopped and displayed) on the variable display portions 21 to 25 with no relation to the activated pay lines, that is, if the case “4K” is realized, the payout number “10” can be obtained. Further, if five symbols “SARDINE” appear (are stopped and displayed) on the variable display portions 21 to 25 with no relation to the activated pay lines, that is, if the case “5K” is realized, the payout number “125” can be obtained.

Here, concerning with only the payout obtained by the symbol “SARDINE”, the payout number calculated by multiplying the payout number shown in FIG. 13 with the total bet number (a product of the bet number and the number of activated pay line) is added to the credit. At that time, if it exists the payout other than the payout on the basis of the symbol “SARDINE”, such payout is also added to the credit.

And as for the symbol “SARDINE”, in a case that more than three symbols “SARDINE” are totally stopped and displayed on the variable display portions 21 to 25 with no relation to the activated pay lines, not only the above payout can be obtained but also the game state can be shifted to the bonus game.

Here, the bonus game is a game which is conducted after the base game is terminated, and in many cases the bonus game is generally more beneficial for the player. If the game state shifts to the bonus game, 15˜25 games can be continuously and automatically executed without betting any credits corresponding to a result of the lottery conducted when the game state shifts to the bonus game.

By the way, in the slot machine 1 according to the embodiment, when the bonus game is conducted, the symbol column variably displayed while being scrolled on the variable display portion 21 of the lower liquid crystal display 4 is the symbol column indicated by the first reel strip 123 shown in FIG. 22, the symbol column variably displayed while being scrolled on the variable display portion 22 of the lower liquid crystal display 4 is the symbol column indicated by the second reel strip 124 shown in FIG. 22, the symbol column variably displayed while being scrolled on the variable display portion 23 of the lower liquid crystal display 4 is the symbol column indicated by the third reel strip 125 shown in FIG. 22, the symbol column variably displayed while being scrolled on the variable display portion 24 of the lower liquid crystal display 4 is the symbol column indicated by the fourth reel strip 126 shown in FIG. 22 and the symbol column variably displayed while being scrolled on the variable display portion 25 of the lower liquid crystal display 4 is the symbol column indicated by the fifth reel strip 127 shown in FIG. 22.

Here, the symbol columns indicated by the reel strips 123 to 126 shown in FIG. 22 are as same as those indicated by the reel strips 101 to 104 shown in FIG. 12. On the other hand, the symbol column indicated by the reel strip 127 shown in FIG. 22 is substantially as same as the symbol column indicated by the reel strip 105 shown in FIG. 22, except for the symbol “WILD” allotted to the code No. “10”.

Here, as the bet number and the number of activated pay line in the bonus game, the bet number and the number of activated pay line set in the base game are utilized, respectively. And in the bonus game, although the winning symbol combinations and payouts thereof in the bonus game are as same as those in the base game, the symbol “SHARK” is regarded as the symbol “WILD” and if more than three symbols “SARDINE” totally appear (are totally stopped and displayed), the game state in the bonus game can be again shifted to the bonus game. Therefore, the player can obtain a lot of credits in many cases.

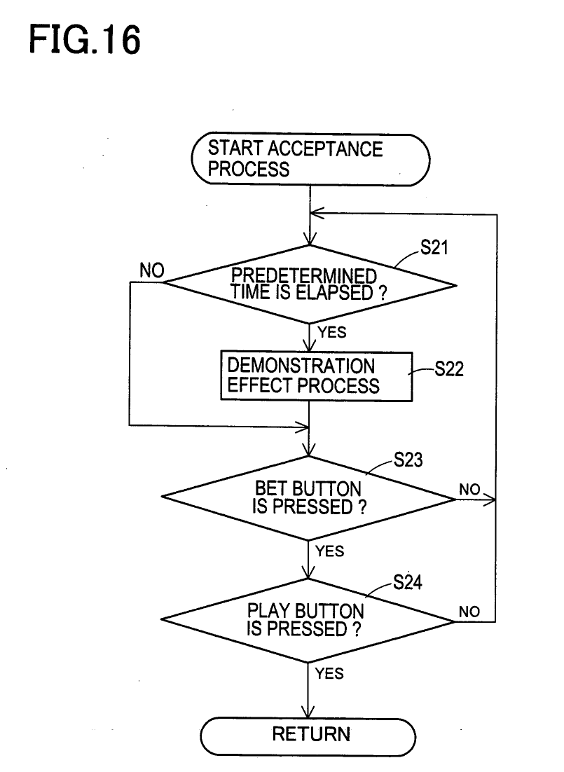

Next, the main process program executed in the slot machine 1 will be described with reference to FIG. 15. FIG. 15 is a flowchart of the main process program. In FIG. 15, at first, in step (abbreviated as “S” hereinafter) 11, a start acceptance process shown in FIG. 16 is executed. This process is a process for accepting the switch signal output from the 1-BET switch 57, the 2-BET switch 58, the 3-BET switch 59, the 5-BET switch 60, the 8-BET switch 61, the 1-LINE switch 62, the 2-LINES switch 63, the 5-LINES switch 64, the 20-LINES switch 65, the 25-LINES switch 66, based on operation of the BET 1 PER LINE button 33, the BET 2 PER LINES button 34, the BET 3 PER LINES button 35, the BET 5 PER LINES 36, the BET 8 PER LINES button 37, the RED PLAY 1 LINE button 39, the PLAY 2 LINES button 40, the PLAY 5 LINES button 41, the PLAY 20 LINES button 42 or the BLACK PLAY 25 LINES button 43. When the switch signal output from each switch is accepted, the game is started.

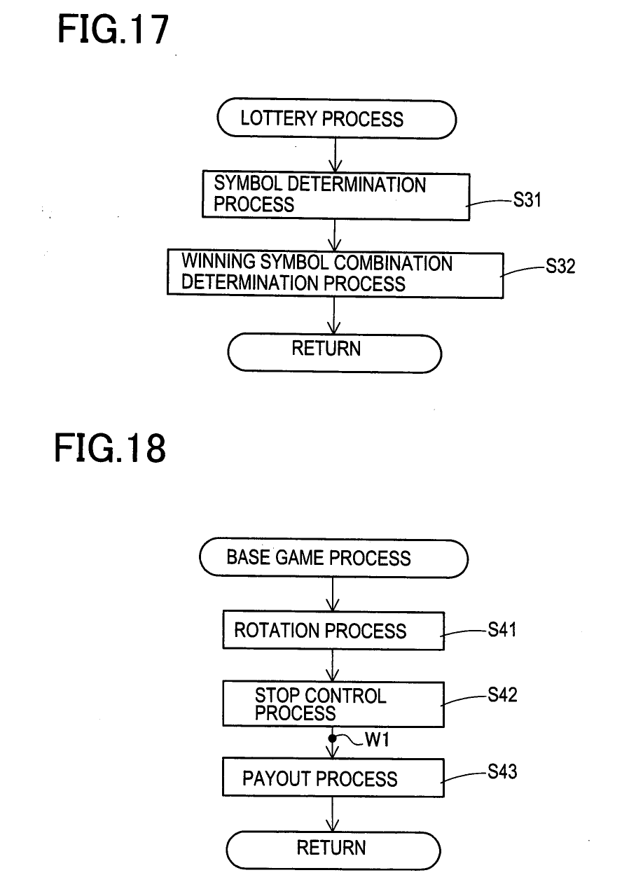

And in S12, a lottery process shown in FIG. 17 mentioned later is executed based on the switch signal output from the 1-LINE switch 62, the 2-LINES switch 63, the 5-LINES switch 64, the 20-LINES switch 65, the 25-LINES switch 66.

Here, if the bonus game is won, a repeat number of the bonus game is determined. In this case, for example, such repeat number is selected among 10˜25 games by a lottery.

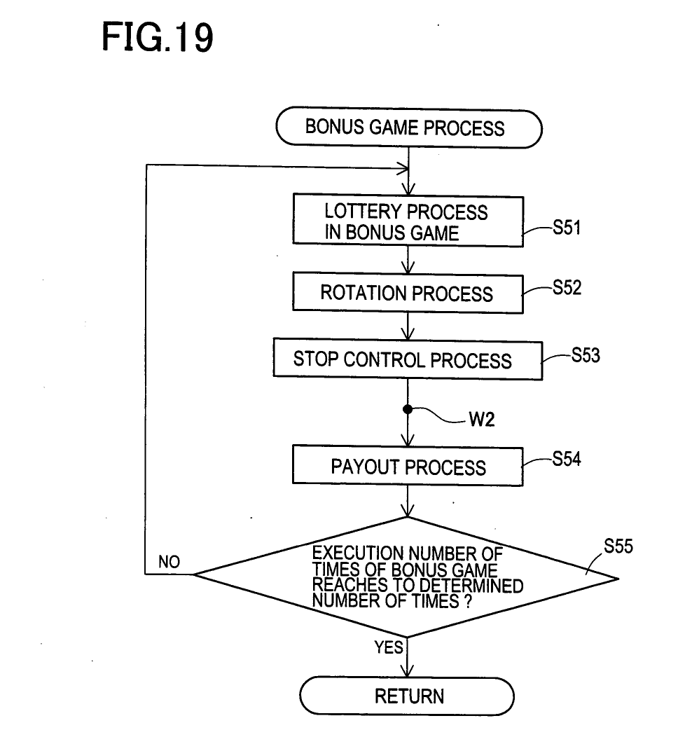

Next, in S13, a base game process shown in FIG. 18 mentioned later is executed. Thereafter, procedure shifts to S14 and it is determined whether or not the bonus game is won. Concretely, in the lottery process in S12, if more than three symbols “SARDINE” totally appear (are stopped and displayed) on the variable display portions 21 to 25 with no relation to the activated pay lines, the bonus game is won (S14: YES). Thereby, procedure shifts to S15 and the main process program is terminated after the bonus game process shown in FIG. 19 mentioned later is executed. On the other hand, in the lottery process of S12, if more than three symbols “SARDINE” does not totally appear (are not stopped and displayed) on the variable display portions 21 to 25 with no relation to the activated pay lines, the bonus game is not won (S14: NO), thereby the main process program is terminated.

Next, the start acceptance process program conducted in the slot machine 1 will be described with reference to FIG. 16. FIG. 16 is a flowchart of the start acceptance process program. In S11 of the main process program shown in FIG. 15, the start acceptance process is conducted. Here, to conduct this process, at first, procedure shifts to S21 of FIG. 16 and it is determined whether or not a predetermined time (for example, 15 seconds) is elapsed. Here, if it is determined that the predetermined time is not elapsed (S21: NO), procedure shifts to S23, and on the other hand, if it is determined that the predetermined time is elapsed (S21: YES), demonstration effect is done on the upper liquid crystal display 3 or the lower liquid crystal display 4 in S22, thereafter procedure shifts to S23. And in S23, it is determined whether or not operation of the BET 1 PER LINE button 33, the BET 2 PER LINE button 34, the BET 3 PER LINE button 35, the BET 5 PER LINE button 36, or the BET 8 PER LINE button 37 is conducted. Here, if it is determined that operation of the above button such as the BET 1 PER LINE button 33 and the like is not conducted (S23: NO), procedure returns to S21 and the above processes are repeated. On the other hand, if it is determined that operation of the above button such as the BET 1 PER LINE button 33 and the like is conducted (S23: YES), procedure shifts to S24. And in S24, it is determined whether or not operation of the RED PLAY 1 LINE button 39, the PLAY 2 LINES button 40, the PLAY 5 LINES button 41, the PLAY 20 LINES button 42, the BLACK PLAY 25 LINES button 43 is conducted. Here, if it is determined that operation of the RED PLAY 1 LINE button 39 and the like is not done (S24: NO), procedure returns to S21 and the above procedures are repeated. On the other hand, if it is determined that operation of the RED PLAY 1 LINE button 39 and the like is done (S24: YES), procedure returns to the main process program of FIG. 15 and shifts to the lottery process in S12 even while the demonstration effect is done.

Here, in the determination process in S24, such determination may be conducted based on the other input signals other than the above operation signals.

Next, the lottery process program executed in the slot machine 1 will be described with reference to FIG. 17. FIG. 17 is a flowchart of the lottery process program. In S12 of the main process program shown in FIG. 15, the lottery process is executed. To conduct this process, at first, procedure shifts to S31 of FIG. 17 and a symbol determination process is conducted. Here, the symbols stopped and displayed on the first activated pay line L1 in the base game are determined every each of the variable display portions 21 to 25. Concretely, as mentioned above, five random number values are sampled by the random number sampling circuit 56 so as to correspond to each of the variable display portions 21 to 25 and the symbols stopped and displayed are determined through the code Nos. based on the first lottery table. And if the symbols stopped and displayed on the activated pay line are determined, a determination process of the winning symbol combination is executed in S32, thereafter procedure returns to the main process program in FIG. 15 and shifts to the base game process in S13. Here, concretely speaking, in the determination process of the winning symbol combination, the winning symbol combination and the payout thereof are determined based on the table shown in FIG. 13 through the code No. obtained in S31, as mentioned.

Here, the first pay line corresponds to the pay line constructed from the second stop display areas 212, 222, 232, 242, 252.

Next, the base game process program executed in the slot machine 1 will be described with reference to FIG. 18. FIG. 18 is a flowchart of the base game process. program. In S13 of the main process program shown in FIG. 15, the base game is conducted. To realized this, at first, in S41 of FIG. 18, scroll of each of the symbols is done on the variable display portions 21 to 25 based on the switch signal output from the 1-LINE switch 62, the 2-LINES switch 63, the 5-LINES switch 64, the 20-LINES switch 65 or the 25-LINES switch 66, the switch signal being accepted in Sll of FIG. 16.

And in S42, scroll of each of the symbols on the variable display portions 21 to 25 is stopped.

Further, in S43, according to the symbol combination corresponding to the winning symbol combination stopped and displayed on the variable display portions 21 to 25, the credit corresponding to the payout determined on the basis of the table shown in FIG. 13 is paid out. Here, after process in S43 is executed, procedure shifts to the main process program shown in FIG. 15 and shifts to the determination process in S14.

Next, the bonus game process program executed in the slot machine 1 will be described with reference to FIG. 19. FIG. 19 is a flowchart of the bonus game process program. In S14 of the main process program shown in FIG. 15, if it is determined that the bonus game is won (S14: YES), procedure shifts to S15 of FIG. 15 and the bonus game process is conducted. To realize this, at first, procedure shifts to S51 shown in FIG. 19 and the lottery process during the bonus game is executed. Here, in the bonus game, the symbols stopped and displayed on the first activated pay line L1 are determined every each of the variable display portions 21 to 25. Concretely, as mentioned, five random number values are sampled by the random number sampling circuit 56 so as to correspond to each of the variable display portions 21 to 25, and the symbols stopped and displayed are determined through the code Nos. based on the first lottery table. And if the symbols stopped and displayed on the pay line are determined, the winning symbol combination and the payout thereof are determined based on the table shown in FIG. 13 through the code Nos.

Further, in the rotation process in S52, scroll of each of the symbols is automatically done on the variable display portions 21 to 25.

And in the stop control process in S53, scroll of each of the symbols on the variable display portions 21 to 25 is stopped.

Further, in the payout process in S54, according to the symbol combination corresponding to the winning symbol combination stopped and displayed on the variable display portions 21 to 25, the credit corresponding to the payout determined based on the table in FIG. 13 (however, the symbol “SHARK” is regarded as the symbol “WILD” (English characters)) is paid out.

Next, procedure shifts to S55 and it is determined whether or not the execution number of times of the bonus game reaches to the number of times determined in S12 of FIG. 15. At that time, if it is determined that the execution number of times of the bonus game does not reach to the number of times already determined in S12 of FIG. 15 (S55: NO), procedure returns to S51 and the above processes are repeated. On the other hand, if it is determined that the execution number of times of the bonus game reaches to the number of times already determined in S12 of FIG. 15 (S55: YES), the bonus game process program is terminated.

Here, if the bonus game is won in S51, the repeat number of times of the bonus game is determined again and the determined repeat number of times is added to the “number of times determined in S12 of FIG. 15” used in the determination process in S55. Thereby, when the bonus game is won during the bonus game, procedure can again shift to the bonus game. Concretely speaking, for example, in a case that procedure shifts to the bonus game with 20 number of times for the first time and the bonus game with 17 number of times is won in the twelfth bonus game, the bonus games are conducted in 25 times (20 times−12 times+17 times) thereafter.

And if the credit can be finally obtained in the bonus game, a double down game to bet the credit is executed after the bonus game is terminated. This double down game will be omitted.

By the way, in the slot machine 1 of the embodiment, if the player contacts to the reel strips 101 to 105 through the variable display portions 21 to 25 (the touch panel 121) during a predetermined time (for example, 5 seconds) after all of the reel strips 101 to 105, which are scrolled in the variable display portions 21 to 25 in both the base game and the bonus game, are stopped, scroll and stop of each of the reel strips 101 to 105 to which the player contacts can be again conducted.

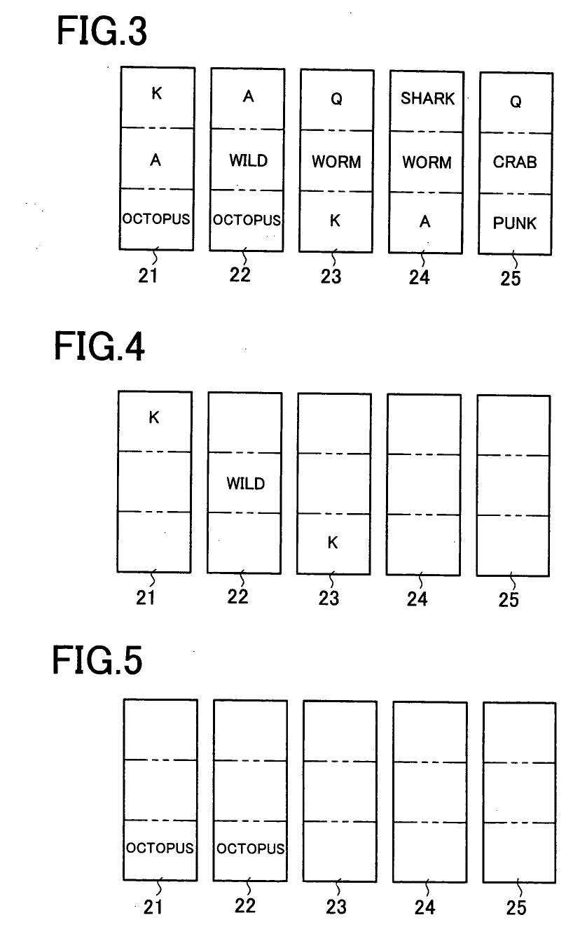

Concretely speaking, for example, in the base game process in FIG. 18 or the bonus game process in FIG. 19, scroll and stop of the reel strips 101 to 105 are done o the variable display portions 21 to 25, and if the symbols shown in FIG. 3 are stopped and displayed and the player contacts to any of the variable display portions 21 to 25 through the touch panel 121 during a predetermined time (for example, 5 seconds) after all of the reel strips 101 to 105 are stopped, scroll and stop of the reel strip 101 to 105 in the variable display portions 21 to 25 to which the player contacts are again conducted.

Here, in a case that the symbols shown in FIG. 3 are stopped and displayed, the symbol “WILD” substitutable for the symbol “K” (English character) is stopped and displayed in the variable display portion 22. Therefore, depending on the number of the activated pay line, this case itself may correspond to the case that the symbols “K” (English character) are sequentially stopped and displayed on the activated pay line in the variable display portions 21 to 23 (the case “3K” that three symbols “K” sequentially appear from the most left end). As a result, according to this case, “5” as the payout coins are obtained. Therefore, in this case, if the player takes a way to certainly obtain “5” coins by fixing the symbols in the variable display portions 21 to 23 (reel strips 101 to 103), it concludes that the player contacts to the variable display portions 24 and 25, and scroll and stop of the symbols (reel strips 104, 105) in the variable display portions 24 and 25 are again conducted.

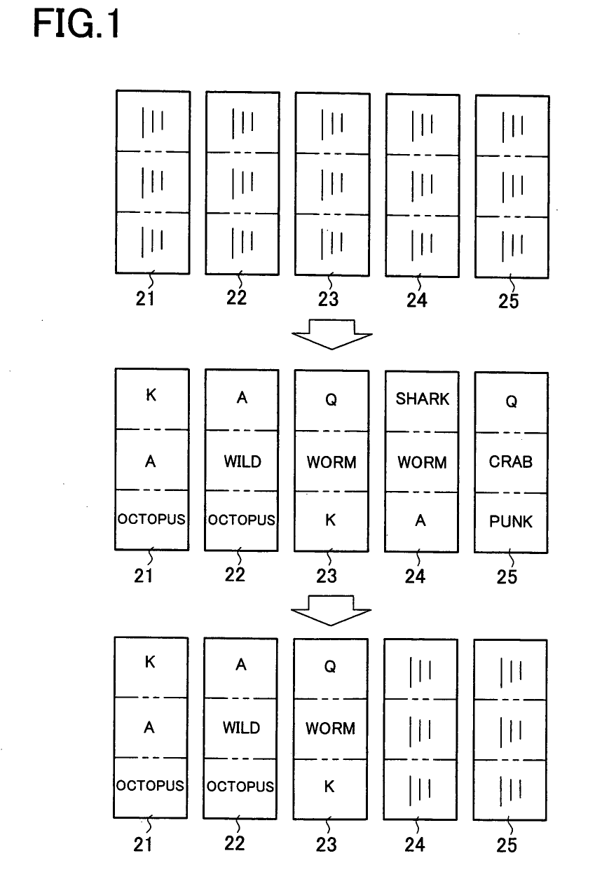

Here, in FIG. 1, change process of the variable display portions 21 and 25 in the above case is shown.

And if the above way is taken, depending on the symbols again stopped and displayed in the variable display portions 24 and 25, it is conceivable a case that the symbols “K” (English character) are sequentially stopped and displayed on the activated pay line in the variable display portions 21 to 24 (the case “4K” that four symbols “K” sequentially appear from the most left end). As a result, the above case (the case “3K”) is developed to the case in which “25” coins are obtained, or is developed to the case that the symbols “K” (English character) are sequentially stopped and displayed on the activated pay line in the variable display portions 21 to 25 (the case “5K” that five symbols “K” sequentially appear from the most left end), as a result, there exists possibility that the above case (the case “3K”) is developed to the case in which “120” coins can be obtained.

However, in a case that the symbols shown in FIG. 3 are stopped and displayed, the other case may be conceivable. That is to say, depending on the number of the activated pay line, the above case itself may correspond to the case that the symbols “OCTOPUS” are sequentially stopped and displayed on the activated pay line in the variable display portions 21 and 22 (the case “2K” that two symbols “OCTOPUS” sequentially appear from the most left end). As a result, according to this case, “2” coins are obtained. Therefore, in this case, if the player takes a way to certainly obtain “2” coins by fixing the variable display portions 21 and 22 (reel strips 101, 102), it concludes that the player contacts to the variable display portions 23 and 25, and scroll and stop of the symbols (reel strips 103, 104, 105) in the variable display portions 23 to 25 are again conducted.

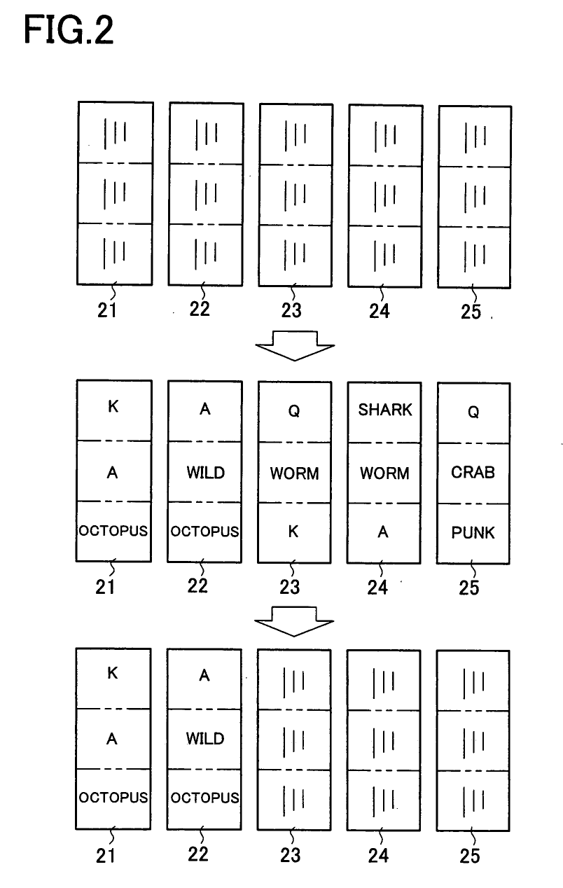

Here, in FIG. 2, change process of the variable display portions 21 and 25 in the above case is shown.

And if the above way is taken, depending on the symbols again stopped and displayed in the variable display portions 23 and 25, it is conceivable a case that the symbols “OCTOPUS” are sequentially stopped and displayed on the activated pay line in the variable display portions 21 to 23 (the case “3K” that three symbols “OCTOPUS” sequentially appear from the most left end). As a result, the above case (the case “3K”) is developed to the case in which “8” coins are obtained, or is developed to the case that the symbols “OCTOPUS” are sequentially stopped and displayed on the activated pay line in the variable display portions 21 to 24 (the case “4K” that four symbols “OCTOPUS” sequentially appear from the most left end), as a result, there exists possibility that the above case (the case “3K”) is developed to the case in which “300” coins can be obtained.

Hereinafter, for convenience to explain, it is supposed that the case that the symbols shown in FIG. 3 are stopped and displayed corresponds to the case that the symbols “K” (English character) are sequentially stopped and displayed on the activated pay line in the variable display portions 21 to 23 as shown in FIG. 4 (the case “3K” that three symbols “K” sequentially appear from the most left end) and to the case that the symbols “OCTOPUS” are sequentially stopped and displayed on the activated pay line in the variable display portions 21 and 22 as shown in FIG. 5 (the case “2K” that two symbols “OCTOPUS” sequentially appear from the most left end). Therefore, if the symbols shown in FIG. 3 are stopped and displayed, two winning symbol combinations are realized at the same time, thus “7” (=5+2) coins can be obtained.

Therefore, if the player regards it as important to certainly obtain “7” coins, the player fixes the symbols (reel strips 101 to 103 in the variable display portions 21 to 23 in which two symbol combinations causing “7” coins are stopped and displayed, thereafter it is conceivable that the player touches the variable display portions 24 and 25, and takes a way to again conduct scroll and stop of the symbols (reel strips 104 and 105) of the variable display portions 24 and 25.

And if the player regards it as important to obtain the payout larger than “7” coins rather than to certainly obtain “7” coins, the player does not persist in fixing the symbols (reel strips 101 to 103) in the variable display portions 21 to 23 in which two symbol combinations to give “7” coins are stopped and displayed, thereafter it is conceivable that the player touches the variable display portions 23 to 25 and takes a way to again conduct scroll and stop of the symbols (reel strips 103 to 105) of the variable display portions 23 to 25, or the player touches the variable display portions 22 to 25 and takes a way to again conduct scroll and stop of the symbols (reel strips 102 to 105) of the variable display portions 22 to 25, or the player touches the variable display portions 21 to 25 and takes a way to again conduct scroll and stop of the symbols (reel strips 101 to 105) of the variable display portions 21 to 25.

As mentioned, in a case that the symbols shown in FIG. 3 are stopped and displayed, in order to obtain more coins, the player can conduct selection and instruction concerning with the symbols (reel strips 101 to 105) of the variable display portions 21 to 25 in which scroll and stop of the symbols are again conducted, through the touch panel 121, thereby based on the selection and instruction, strategy of the player for the game can be reflected.

Here, in the embodiment, when scroll and stop of the reel strips 101 to 105 in the variable display portions 21 to 25 are conducted and all of the symbols are stopped and displayed, for example, as shown in FIG. 3, if the symbol “WILD” substitutable for any of the symbols is stopped and displayed, or if the winning symbol combination is realized on the activated pay line, the above selection and instruction to again conduct scroll and stop against the symbols (reel strips 101 to 105) of the variable display portions 21 to 25 cannot be accepted unless the BET 1 PER LINE button 34, the BET 2 PER LINE BUTTON 35, the BET 5 PER LINE button 36 or the BET 8 PER LINE button 37 is operated, thereby the bet operation is newly done.

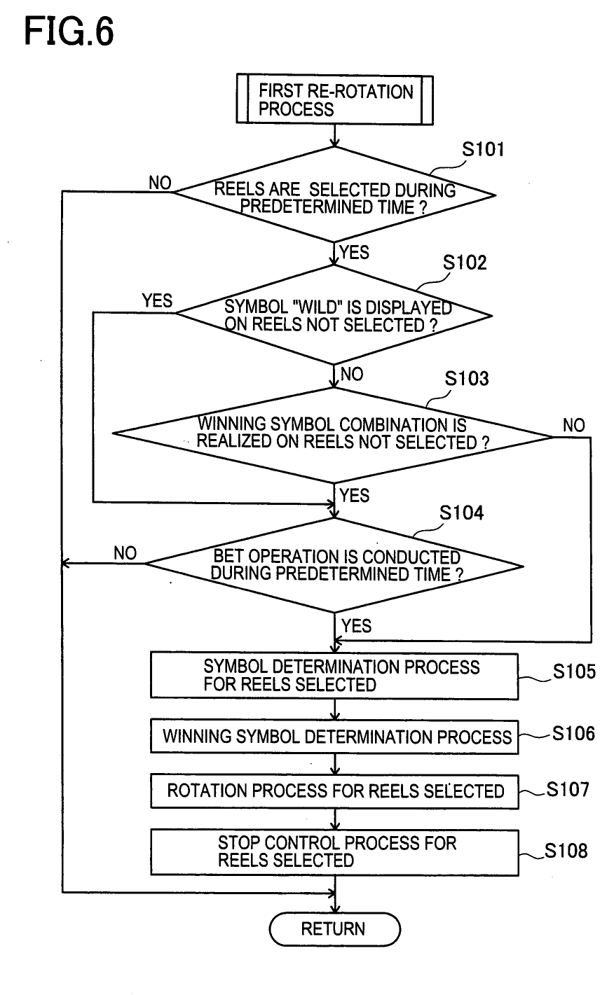

Thus, for example, the first re-rotation process program shown in FIG. 6 is executed at the point W1 right after the stop control process of S42 in the base game process program in FIG. 18 is done, or at the point W2 right after the stop control process of S53 in the bonus game process program in FIG. 19 is done. That is to say, after the stop control process of S42 in the base game process program in FIG. 18 is done, or after the stop control process of S53 in the bonus game process program in FIG. 19 is done, procedure shifts to S101 in FIG. 6 and it is determined whether or not the reel strips 101 to 105 to again conduct scroll and stop thereof are selected during a predetermined time (for example, 5 seconds).

Here, as mentioned, the selection at that time is conducted based on that the player touches any of the variable display portions 21 to 25 through the touch panel 121.

And as the count start point of the predetermined time (for example, 5 seconds), for example, there will exist the time point from which the first re-rotation process program is started to execute.

At that time, if it is determined that the reel strips 101 to 105 to again conduct scroll and stop are selected during the predetermined time (for example, 5 seconds) (SlOl: YES), procedure shifts to S102 and it is determined whether or not the symbol “WILD” is stopped and displayed in the reel strips 101 to 105 (variable display portions 21 to 25) which are not selected (out of selection).

At that time, if it is determined that the symbol “WILD” is stopped and displayed in the reel strips 101 to 105 (variable display portions 21 to 25) which are not selected (S102: YES), procedure shifts to S104. On the contrary, if it is determined that the symbol “WILD” is not stopped and displayed in the reel strips 101 to 105 (variable display portions 21 to 25) which are not selected (S102: NO), procedure shifts to S103, and further it is determined whether or not the winning symbol combination is realized in the reel strips 101 to 105 (variable display portions 21 to 25) which are not selected.

At that time, if it is determined that the winning symbol combination is not realized in the reel strips 101 to 105 (variable display portions 21 to 25) which are not selected (S103: NO), procedure shifts to S105 mentioned later. On the other hand, if it is determined that the winning symbol combination is realized in the reel strips 101 to 105 (variable display portions 21 to 25) which are not selected (S103: YES), procedure shifts to S104.

In S104, it is determined whether or not bet operation is done during a predetermined time (for example, 10 seconds). In this determination, based on operation of the BET 1 PER LINE button 33, the BET 2 PER LINE button 34, the BET 3 PER LINE button 35, the BET 5 PER LINE button 36 or the BET 8 PER LINE button 37, it is determined whether or not the switch signal output from the 1-BET switch 57, the 2-BET switch 58, the 3-BET switch 59, the 5-BET switch 60 or the 8-BET switch 61 is accepted.

Here, as the count start point of the predetermined time (for example, 10 seconds), for example, there will exist the time point from which the first re-rotation process program is started to execute.

At that time, if it is determined that bet operation is done during the predetermined time (for example, 10 seconds) (S104: YES), procedure shifts to S105 and it is conducted the symbol determination process for the reel strips 101 to 105 (variable display portions 21 to 25) which are selected. Here, in the base game or the bonus game, the symbols stopped and displayed on the first pay line are determined every each of the variable display portions 21 to 25 (each of the reel strips 101 to 105) which are selected. Concretely, as mentioned, the random number values are voluntarily sampled by the random number sampling circuit 56 so as to correspond to each of the variable display portions 21 to 25 (each of the reel strips 101 to 105) and the stop display symbols are determined through the code Nos. corresponding to the random number values based on the first lottery table.

And as for the reel strips 101 to 105 (variable display portions 21 to 25) which are selected, the symbols stopped and displayed on the activated pay line are determined, thereafter the winning symbol combination determination process is conducted in S106. In this winning symbol combination determination process, as for all of the reel strips 101 to 105 (variable display portions 21 to 25) including those not selected, the winning symbol combination and the payout thereof are determined based on the table shown in FIG. 13 through the code Nos..

Further, in the rotation process in S107, scroll of each of the symbols is automatically done in the reel strips 101 to 105 (variable display portions 21 to 25) which are selected.

And in S108, scroll of each of the symbols scrolling in the reel strips 101 to 105 (variable display portions 21 to 25) is stopped.

Further, thereafter, procedure shifts to the payout process in S43 in the base game process program shown in FIG. 18 or the payout process in S54 in the bonus game process program shown in FIG. 19.

And in S101 mentioned in the above, it is determined that the reel strips 101 to 105 (variable display portions 21 to 25) to again conduct scroll and stop are not selected during the predetermined time (for example, 5 seconds)(S11: NO), or in S104 mentioned in the above, if it is determined that bet operation is not done during the predetermined time (for example, 10 seconds) (S104: NO), thereafter procedure shifts to the payout process in S43 in the base game process program shown in FIG. 18 or the payout process in S54 in the bonus game process program shown in FIG. 19.

The present invention is not limited to the embodiment and various modifications and changes can be done within the scope of the present invention.

For example, in the slot machine 1 according to the embodiment, in a case that the player touches the reel strips 101 to 105 scrolled and stopped in the variable display portions 21 to 25 through the touch panel 121 during the predetermined time (for example, 5 seconds) after all of the reel strips are stopped, scroll and stop of the reel strips 101 to 105 touched by the player can be again conducted in the above base game and the bonus game by conducting the first re-rotation process in FIG. 6.

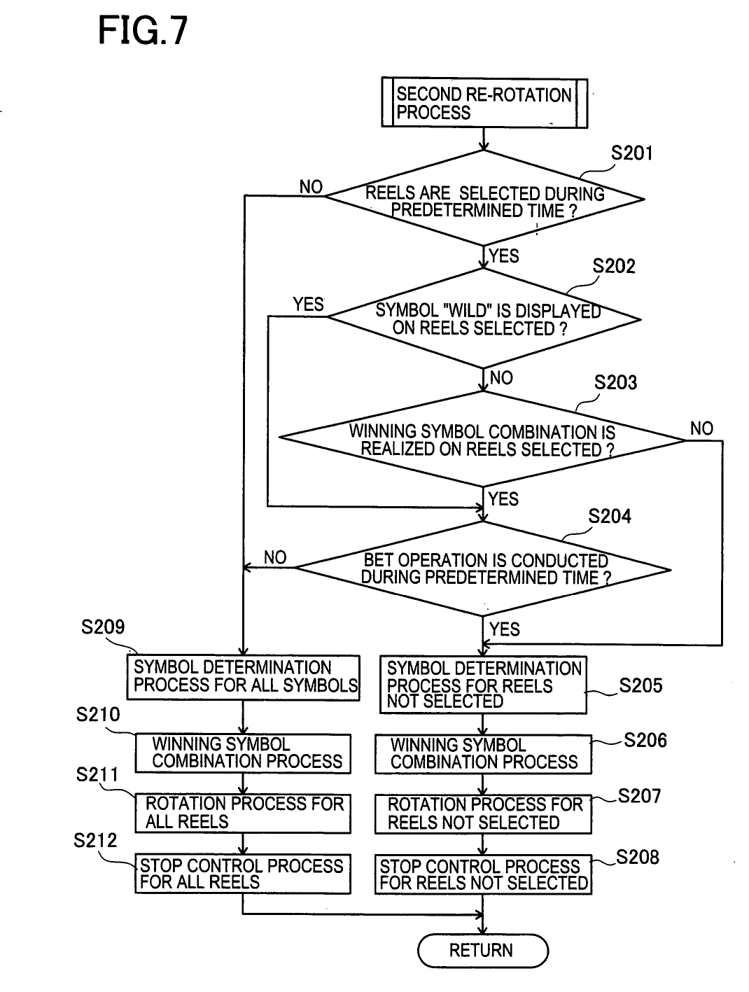

Here, although the player selects the reel strips 101 to 105 which are again scrolled and stopped, on the contrary, the reel strips 101 to 105, which are fixed without again conducting scroll and stop, may be selected by the player. To realize this, the second re-rotation process shown in FIG. 7 is conducted instead of the first re-rotation process shown in FIG. 6.

Here, the second re-rotation process shown in FIG. 7 will be described. The second re-rotation process shown in FIG. 7 is executed at the point WI right after the stop control process of S42 in the base game process program in FIG. 18 is conducted, or at the point W2 right after the stop control process of S53 in the bonus game process program in FIG. 19 is conducted.

That is to say, in the base game process program in FIG. 18, after the stop control process of S42 is done, or in the bonus game process program in FIG. 19, after the stop control process of S53 is done, procedure shifts to S201 in FIG. 7, and it is determined whether or not the reel strips 101 to 105, which are fixed without again conducting scroll and stop, are selected during the predetermined time (for example, 5 seconds).

Here, as mentioned, this selection is conducted based on that the player touches any of the variable display portions 21 to 25 through the touch panel 121.

And as the count start point of the predetermined time (for example, 5 seconds), for example, there will exist the time point from which the second re-rotation process program is started to execute.

At that time, if it is determined that the reel strips 101 to 105, which are fixed without again conducting scroll and stop, are selected during the predetermined time (for example, 5 seconds) (S201: YES), procedure shifts to S202 and it is determined whether or not the symbol “WILD” is stopped and displayed in the reel strips 101 to 105 (variable display portions 21 to 25) which are selected.

At that time, if it is determined that the symbol “WILD” is stopped and displayed in the reel strips 101 to 105 (variable display portions 21 to 25) which are selected (S202: YES), procedure shifts to S204 mentioned later. On the contrary, if it is determined that the symbol “WILD” is not stopped and displayed in the reel strips 101 to 105 (variable display portions 21 to 25) which are selected (S202: NO), procedure shifts to S103, and further it is determined whether or not the winning symbol combination is realized in the reel strips 101 to 105 (variable display portions 21 to 25) which are selected.

At that time, if it is determined that the winning symbol combination is not realized in the reel strips 101 to 105 (variable display portions 21 to 25) which are selected (S203: NO), procedure shifts to S205 mentioned later. On the other hand, if it is determined that the winning symbol combination is realized in the reel strips 101 to 105 (variable display portions 21 to 25) which are selected (S203: YES), procedure shifts to S204.

In S 204, it is determined whether or not bet operation is done during a predetermined time (for example, 10 seconds). In this determination, based on operation of the BET 1 PER LINE button 33, the BET 2 PER LINE button 34, the BET 3 PER LINE button 35, the BET 5 PER LINE button 36 or the BET 8 PER LINE button 37, it is determined whether or not the switch signal output from the 1-BET switch 57, the 2-BET switch 58, the 3-BET switch 59, the 5-BET switch 60 or the 8-BET switch 61 is accepted.

Here, as the count start point of the predetermined time (for example, 10 seconds), for example, there will exist the time point from which the second re-rotation process program is started to execute.

At that time, if it is determined that bet operation is done during the predetermined time (for example, 10 seconds) (S204: YES), procedure shifts to S205 and it is conducted the symbol determination process for the reel strips 101 to 105 (variable display portions 21 to 25) which are not selected. Here, in the base game or the bonus game, the symbols stopped and displayed on the first pay line are determined every each of the variable display portions 21 to 25 (each of the reel strips 101 to 105) which are not selected. Concretely, as mentioned, the random number values are voluntarily sampled by the random number sampling circuit 56 so as to correspond to each of the variable display portions 21 to 25 (each of the reel strips 101 to 105) and the stop display symbols are determined through the code Nos. corresponding to the random number values based on the first lottery table.

And as for the reel strips 101 to 105 (variable display portions 21 to 25) which are not selected, the symbols stopped and displayed on the activated pay line are determined, thereafter the winning symbol combination determination process is conducted in S206. In this winning symbol combination determination process, as for all of the reel strips 101 to 105 (variable display portions 21 to 25) including those selected, the winning symbol combination and the payout thereof are determined based on the table shown in FIG. 13 through the code Nos..

Further, in the rotation process in S207, scroll of each of the symbols is automatically done in the reel strips 101 to 105 (variable display portions 21 to 25) which are not selected.

And in S208, scroll of each of the symbols scrolling in the reel strips 101 to 105 (variable display portions 21 to 25) not selected is stopped.

Further, thereafter, procedure shifts to the payout process in S43 in the base game process program shown in FIG. 18 or the payout process in S54 in the bonus game process program shown in FIG. 19.

On the other hand, in S201 mentioned in the above, if it is determined that the reel strips 101 to 105, which are fixed without again conducting scroll and stop, are not selected during the predetermined time (for example, 5 seconds)(S201: NO), or if it is determined in S204 that bet operation is not done during the predetermined time (for example, 10 seconds) (S204: NO), procedure thereafter shifts to S209.

In S209, it is conducted the symbol determination process for all of the reel strips 101 to 105 (variable display portions 21 to 25). Here, in the base game or the bonus game, the symbols stopped and displayed on the first pay line are determined every each of the variable display portions 21 to 25 (each of the reel strips 101 to 105). Concretely, as mentioned, the random number values are voluntarily sampled by the random number sampling circuit 56 so as to correspond to each of all of the variable display portions 21 to 25 (each of the reel strips 101 to 105) and the stop display symbols are determined through the code Nos. corresponding to the random number values based on the first lottery table.

And as for all of the reel strips 101 to 105 (variable display portions 21 to 25), after the symbols stopped and displayed on the activated pay line, the winning symbol combination determination process is executed in S210. In this winning symbol combination determination process, the winning symbol combination and the payout thereof are determined based on the table of FIG. 13 through the code Nos in all of the reel strips 101 to 105 (variable display portions 21 to 25).

Further, in the rotation process in S211, scroll of each of the symbols is automatically done in all of the reel strips 101 to 105 (variable display portions 21 to 25).

And in S212, scroll of each of the symbols scrolling in all of the reel strips 101 to 105 (variable display portions 21 to 25) is stopped.

Further, thereafter, procedure shifts to the payout process in S43 in the base game process program shown in FIG. 18 or the payout process in S54 in the bonus game process program shown in FIG. 19.

Therefore, in the second re-rotation process shown in FIG. 7. although the player selects the reel strips 101 to 105 which are fixed without again conducting scroll and stop, procedure shifts to S209 and following steps if selection of the reel strips is not conducted (S201: NO), or if bet operation is not done during the predetermined time (S204: NO), thereafter scroll and stop of all of the reel strips 101 to 105 are again conducted.

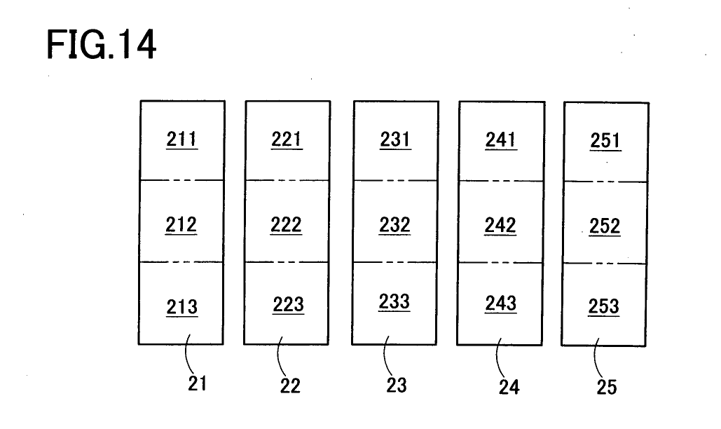

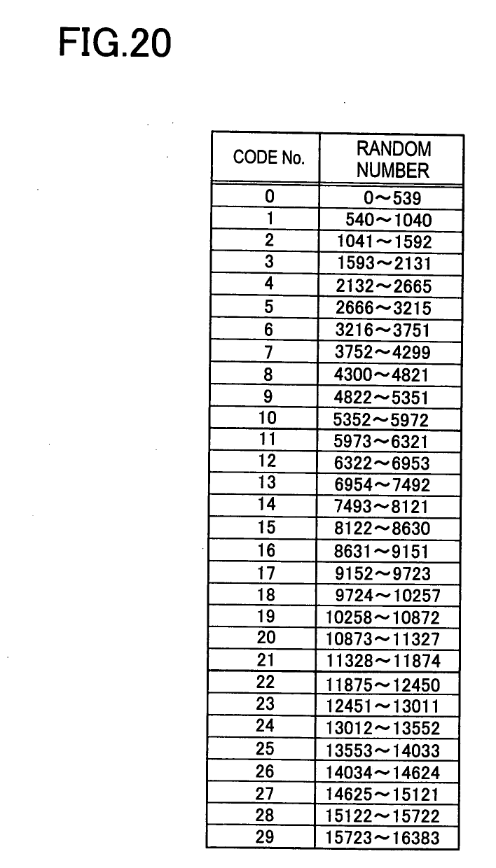

Further, in the slot machine 1 of the embodiment, the symbol stopped and displayed on the pay line constructed from the second stop display areas 212, 222, 232, 242, 252 is determined every each of the variable display portions 21 to 25 in the base game and the bonus game, based on the lottery table in FIG. 14 in which one random number value sampled through the random number sampling circuit 56 and one code No. are corresponded with each other. As for this point, for example, the symbol stopped and displayed on the pay line constructed from the second stop display areas 212, 222, 232, 242, 252 may be determined every each of the variable display portions 21 to 25, based on the lottery table in FIG. 20 in which a specific range of the random numbers sampled through the random number sampling circuit 56 corresponds to one code No.

Further, although the slot machine 1 of the embodiment conducts the video slot game through five reels, it may be conducted the video slot game through three reels or nine reels. And the slot machine may be constructed by using three, five or nine mechanical reels. Further, the slot machine may be constructed form a hybrid type of slot machine in which the video reels and the mechanical reels are used together.

And in the slot machine 1 according to the embodiment, although selection of the reel strips 101 to 105 scroll and stop of which are again conducted, or on the contrary, selection of the reel strips 101 to 105 which are fixed without again conducting scroll and stop, is done through the touch panel 121, a plurality of buttons corresponding to each of the reel strips 101 to 105 may be provided and the above selection may be done by operating such buttons.

Further, in the slot machine 1 according to the embodiment, although selection of the reel strips 101 to 105 scroll and stop of which are again conducted, or on the contrary, selection of the reel strips 101 to 105 which are fixed without again conducting scroll and stop, is done after all of the reel strips 101 to 105 are scrolled and stopped in the variable display portions 21 to 25, the above selection may be done while all or a part of the reel strips 101 to 105 are scrolled in the variable display portions 21 to 25.

The present invention can be adopted for a gaming machine in which the game is executed by using the symbols on plural reels variably displayed and stopped.

What is claimed is:

1. A gaming machine comprising:
a reel display device for displaying a plurality of reels each of which has symbols and is rotated so as to variably display and stop the symbols;
a payout device for paying out game media if a symbol combination constructed from the symbols of the reels corresponds to a winning symbol combination when the reels are stopped;
a selection device for selecting the reel which is rotated;
an acceptance device for accepting a selective instruction from the selection device;
wherein the acceptance device accepts the selective instruction only when the selective instruction is output from the selection device after all of the reels are stopped,
wherein the reel display device displays the reel so as to again rotate corresponding to the selective instruction accepted by the acceptance device, and wherein the payout device pays out the gaming media if the symbol combination constructed from the symbols including the symbol of the reel which is again rotated and stopped corresponds to the winning symbol combination.

2. The gaming machine according to claim 1, further comprising:
a bet device for betting the game media when a game is started;
a first determination device for determining whether or not a wild symbol substitutable for any of the symbols is displayed on any of the reels which are not selected through the selection device;
wherein if it is determined by the first determination device that the wild symbol is displayed on any of the reels which are not selected through the selection device, the acceptance device accepts the selective instruction only in a case that the game media are newly betted through the bet device.

3. The gaming machine according to claim 1, further comprising:
a bet device for betting the game media when a game is started;
a second determination device for determining whether or not the winning symbol combination is realized by the symbols of the reels which are not selected through the selection device;
wherein if it is determined by the second determination device that the winning symbol combination is realized by the symbols of the reels which are not selected through the selection device, the acceptance device accepts the selective instruction only in a case that the game media are newly betted through the bet device.

4. A gaming machine comprising:
a reel display device for displaying a plurality of reels each of which has symbols and is rotated so as to variably display and stop the symbols;
a payout device for paying out game media if a symbol combination constructed from the symbols of the reels corresponds to a winning symbol combination when the reels are stopped;
a selection device for selecting the reels which are fixed so as not to rotate;
an acceptance device for accepting a selective instruction from the selection device;
wherein the acceptance device accepts the selective instruction only when the selective instruction is output from the selection device after all of the reels are stopped, wherein the reel display device displays the reels not selected by the selection device so as to again rotate; and
wherein the payout device pays out the gaming media if the symbol combination constructed from the symbols including the symbols of the reels which are again rotated and stopped corresponds to the winning symbol combination.

5. The gaming machine according to claim 4, further comprising:
a bet device for betting the game media when a game is started;
a first determination device for determining whether or not a wild symbol substitutable for any of the symbols is displayed on any of the reels which are selected through the selection device;
wherein if it is determined by the first determination device that the wild symbol is displayed on any of the reels which are selected through the selection device, the acceptance device accepts the selective instruction only in a case that the game media are newly betted through the bet device.

6. The gaming machine according to claim 4, further comprising:
a bet device for betting the game media when a game is started;
a second determination device for determining whether or not the winning symbol combination is realized by the symbols of the reels which are selected through the selection device;
wherein if it is determined by the second determination device that the winning symbol combination is realized by the symbols of the reels which are selected through the selection device, the acceptance device accepts the selective instruction only in a case that the game media are newly betted through the bet device.
